(19) United States
(12) Patent Application Publication
(10) Pub. No.: US 2025/0300717 A1
(43) Pub. Date: Sep. 25, 2025

(54) COMMUNICATION METHODS, APPARATUSES, NON-TRANSITORY COMPUTER-READABLE STORAGE DEVICES, AND SYSTEMS FOR WIRELESS COMMUNICATION USING HIERARCHICAL BEAM-LAYOUT

(71) Applicant: Huawei Technologies Co., Ltd., Shenzhen (CN)

(72) Inventors: Jalal Khamse-Ashari, Stittsville (CA); Amine Maaref, Ottawa (CA)

(21) Appl. No.: 19/230,769

(22) Filed: Jun. 6, 2025

Related U.S. Application Data
(63) Continuation of application No. PCT/CN2022/137632, filed on Dec. 8, 2022.

(51) Int. Cl. H04B 7/06; H04B 17/318; H04W 72/044; H04W 72/23

(52) U.S. Cl. CPC H04B 7/06952; H04B 17/328; H04W 72/044; H04W 72/23

(57) ABSTRACT

A hierarchical beam-deployment method has the step of transmitting signal beams of multiple levels towards a service area, each signal beam comprising a synchronization signal and physical broadcast channel block (SSB); the footprint of a higher-level beam has a beam-width smaller than that of a lower-level beam, and is at least partially overlapping with the footprint of the lower-level beam. Accordingly, a beam-search method has the steps of detecting a first SSB of a first signal beam; determining, based on the first SSB, a presence of one or more second signal beams having one or more footprints at least partially overlapping with a footprint of the first signal beam; detecting one or more second SSBs of the one or more second signal beams; and selecting at least one of the first and second SSBs for performing an initial-access procedure based on the selected SSB.

### CROSS-REFERENCE TO RELATED APPLICATIONS

This application is a continuation of PCT Application No. PCT/CN2022/137632, entitled “COMMUNICATION METHODS, APPARATUSES, NON-TRANSITORY COMPUTER-READABLE STORAGE DEVICES, AND SYSTEMS FOR WIRELESS COMMUNICATION USING HIERARCHICAL BEAM-LAYOUT,” filed on Dec. 8, 2022, which application is hereby incorporated herein by reference in its entirety.

### TECHNICAL FIELD

The present disclosure relates generally to communication methods, apparatuses, non-transitory computer-readable storage devices, and systems, and in particular to communication methods, apparatuses, non-transitory computer-readable storage devices, and systems for wireless communication using a hierarchical beam-layout.

### REFERENCE TO ACRONYM KEY AND DEFINITIONS OF SOME TECHNICAL TERMS

For ease of reading, subsection C of the Detailed Description list the definitions of some technical terms used in this disclosure.

### BACKGROUND

Mobile communication systems are known. While most mobile communication systems are so-called terrestrial network (TN) systems (which generally comprise a plurality of transmit-receive points (TRPs) deployed on the ground), non-terrestrial network (NTN) systems (which generally comprise a plurality of non-terrestrial TRPs such as satellites and high altitude platform stations (HAPS) deployed above ground or in the space) are also deployed or started their deployment in recent years.

In NTN systems, the non-terrestrial TRPs transmit a plurality of signal beams towards the ground to communicate with UEs on or above the ground using one or a plurality of serving cells. In conventional NTNs, the signal beams are usually deployed in a regular beam-layout pattern (see FIG. 1) such as a honeycomb lattice or grid of beams, wherein the same beam shape is repeated over the entire coverage area. However, the conventional beam-layout has several drawbacks. For example, using the conventional regular/uniform beam-layout over the entire coverage area may not meet a spatiotemporally-varying user-traffic demand (or “UE-traffic demand”). The conventional beam-layout may not efficiently utilize available resources because the resources over some of the beams may be congested while many other beams may be underutilized. Employing the conventional beam-layout may result in excessive energy consumption and signaling overhead due to overprovisioning in regions with a sparse distribution of user equipments (UEs). Moreover, the capacity for a non-terrestrial TRP is usually limited by the number of deployed beams (which is in turn limited by the limited resources such as the number of antennas and radio-frequency (RF) chains, processing power, and/or the like). Thus, it is necessary to deploy the beams in an efficient manner in order to efficiently utilize such limited resources.

### SUMMARY

Embodiments of this disclosure relate to communication methods, apparatuses, non-transitory computer-readable storage devices, and systems for wireless communication using a hierarchical beam-layout.

According to one aspect of this disclosure, there is provided a first method comprising: transmitting a plurality of signal beams towards an area, each signal beam comprising a synchronization signal and physical broadcast channel (PBCH) block (SSB) and associated with a footprint, and each signal beam corresponding to one of a plurality of levels; the footprint of a lower-level beam of the plurality of signal beams at least partially encloses the footprint of a higher-level beam of the plurality of signal beams, and the SSB of the lower-level beam comprises a first indication of the higher-level beam.

With the above method, the beams are deployed in an efficient manner, such as in different levels for different UEs/scenarios in order to efficiently utilize such limited resources.

In some embodiments, the area is a service area for providing communication services to the UEs.

In some embodiments, said transmitting the plurality of signal beams towards the area comprises: transmitting the plurality of SSBs via one or more bandwidth parts (BWPs); each BWP is used for transmitting one or more of the plurality of SSBs.

In some embodiments, said transmitting the plurality of signal beams towards the area comprises: transmitting the SSB of a lowest-level beam of the plurality of signal beams via a predefined bandwidth part (BWP). This may reduce the complexity of the UE for detecting the SSBs and reduce the latency of initial access.

In some embodiments, the first indication is a flag bit.

In some embodiments, said transmitting the plurality of signal beams towards the area comprises: transmitting system information of the lower-level beam, the system information of the lower-level beam comprising information related to the footprint of the higher-level beam, and/or a resource indication indicating a resource where the SSB of the higher-level beam is transmitted. This allows the UE to detect the higher-level beams more conveniently and efficiently to reduce the latency of initial access.

In some embodiments, the system information is in a master information block (MIB) carried by a PBCH, or as remaining system information message carried by a physical downlink shared channel (PDSCH).

In some embodiments, the resource comprise a resource over one or more of time, frequency, space, and code domains.

In some embodiments, the system information of the lower-level beam comprises a first bitmap comprising the resource indication.

In some embodiments, the resource is a predefined resource; and the first bitmap comprises a binary-one as the resource indication for indicating the predefined resource for transmitting the SSB of the higher-level beam.

In some embodiments, the system information of the lower-level beam comprises a second indication indicating whether the higher-level beam is active or inactive.

In some embodiments, the system information of the lower-level beam comprises a second bitmap comprising the second indication.

In some embodiments, the second indication is a binary bit of the second bitmap, where the second indication has a value of binary-one indicating the higher-level beam being active or has a value of binary-zero indicating the higher-level beam being inactive.

In some embodiments, said transmitting the plurality of signal beams towards the area further comprises: transmitting a third indication; the third indication indicates that the footprint of the lower-level beam is divided by the footprints of a set of higher-level beams of the plurality of signal beams into a plurality of partitions.

In some embodiments, the footprints of the set of higher-level beams uniformly divide the footprint of the lower-level beam into the plurality of partitions.

In some embodiments, the third indication is a third bitmap.

In some embodiments, the third bitmap comprises a plurality of binary bits, each bit corresponding to one of the set of higher-level beams, and each bit having a value of binary-one indicating the higher-level beam being active or having a value of binary-zero indicating the higher-level beam being inactive. This may additionally reduce the number of possible higher-level beam to be detected and reduce the complexity and power consumption.

In some embodiments, the plurality of signal beams are transmitted by a plurality of terrestrial and/or non-terrestrial transmit-receive points (TRPs) of a radio access network (RAN), or by a plurality of RANs.

According to one aspect of this disclosure, there is provided a RAN comprising: at least one transmitter; at least one receiver; and at least one processor functionally coupled to the at least one transmitter and the at least one receiver for performing the first method or any one of embodiments of the above-described first method.

According to one aspect of this disclosure, there is provided a first apparatus comprising at least one processor couple with a memory storing computer-executable instructions, when the instructions are executed by the at least one processor, causing the first apparatus to perform the first method or any one of embodiments of the above-described first method. In this disclosure, the first apparatus may be a first device such as a base station, or RAN, or it may be a chipset or a module or a component of the first device.

According to one aspect of this disclosure, there is provided one or more non-transitory computer-readable storage devices comprising computer-executable instructions, wherein the instructions, when executed, cause one or more processors to perform the above-described first method or any one of embodiments of the first method.

According to one aspect of this disclosure, there is provided a second method comprising: detecting a first SSB of a first signal beam; determining, based on the first SSB, a presence of one or more second signal beams each having a footprint at least partially overlapping with a footprint of the first signal beam; detecting one or more second SSBs of the one or more second signal beams; performing an initial-access procedure to a serving cell associated with one or more third SSBs selected from the first and second SSBs.

In some embodiments, the second method further comprises: determining an initial uplink BWP and an initial downlink BWP based on the one or more third SSBs; said performing the initial-access procedure to the serving cell associated with the one or more third SSBs comprises: performing the initial-access procedure to the serving cell using the determined initial uplink and downlink BWPs.

In some embodiments, said determining, based on the first SSB, the presence of the one or more second signal beams comprises: decoding system information based on the first SSB; and determining the presence of the one or more second signal beams based on the decoded system information.

In some embodiments, the one or more third SSBs are selected based on signaling associated with the first and second SSBs.

In some embodiments, the one or more third SSBs are selected based on one or more of reference-signal received powers (RSRPs) of the first and the one or more second SSBs, distances to centers of the first signal beam and the one or more second signal beams, and a probabilistic metric.

In some embodiments, the one or more third SSBs are the first SSB when the RSRP of the first SSB is greater than the RSRP of each of the one or more second SSBs by at least a threshold value.

In some embodiments, the one or more third SSBs comprise one of the one or more second SSBs whose RSRP is greater than a threshold value.

In some embodiments, the one or more third SSBs comprise one of the first and the one or more second SSBs having the greatest RSRP.

In some embodiments, the one or more third SSBs comprise one of the one or more second SSBs, and the one or more third SSBs and the first SSB belong to different types of TRPs or different RANs.

In some embodiments, the different types of TRPs comprise terrestrial TRPs and non-terrestrial TRPs.

In some embodiments, the one or more third SSBs are selected from a subset of the first SSB and the one or more second SSBs.

In some embodiments, the subset of the first SSB and the one or more second SSBs are determined based on one or more of a maximum uplink power and an antenna gain.

According to one aspect of this disclosure, there is provided a second apparatus comprising: a transmitter; a receiver; and a processor functionally coupled to the transmitter and the receiver for performing the above-described second method or any one of embodiments of the above-described second method. In this disclosure, the apparatus may be a second device such as a user equipment, or a communication device, or it may be a chipset or a module or a component of the second device.

According to one aspect of this disclosure, there is provided one or more non-transitory computer-readable storage devices comprising computer-executable instructions, wherein the instructions, when executed, cause one or more processing units to perform the above-described second method or any one of embodiments of the above-described second method.

According to one aspect of this disclosure, there is provided a third apparatus comprising at least one processor couple with a memory storing instructions thereon, when the instructions are executed by the at least one processor, cause the third apparatus to perform the second method or any one of embodiments of the above-described second method. In this disclosure, the third apparatus may be a third device such as a user equipment, or a communication device, or it may be a chipset or a module or a component of the third device.

According to one aspect of this disclosure, there is provided a communication system comprising at least one first apparatus performing the above-described first method and at least one second apparatus performing the above-described second method.

In summary, the communication methods, apparatuses, systems, and non-transitory computer-readable storage devices disclosed herein provide benefits such as:
enhanced resource utilization with improved traffic management by tailoring the beam deployment to adapt to user-traffic demands.

In addition, it may provide various benefits such as:
reduced complexity of beam search at the user equipment (UE) side while ensuring the UE to select a proper beam hierarchy;
simplifying beam switching and reducing the chance of a beam failure by switching between beams of different hierarchy levels;
simplifying beam search on the UE side;
providing flexibility to (re-)configure the SSB transmission pattern for higher-level beams, reducing the overhead for reference signal transmission, and saving energy on the RAN side;
enabling opportunistic energy saving and inter-beam interference management; and
balancing the load across different layers and/or beams.

### BRIEF DESCRIPTION OF THE DRAWINGS

FIG. 1 is a simplified schematic diagram showing the beam layout deployed in a conventional non-terrestrial network (NTN) system;

FIG. 2 is a simplified schematic diagram showing the structure of a communication system, according to some embodiments of this disclosure;

FIG. 3 is a simplified schematic diagram of a controlling device of a communication network of the communication system shown in FIG. 2;

FIG. 4 is a simplified schematic diagram of a transmit-receive point (TRP) of the communication system shown in FIG. 2;

FIG. 5 is a simplified schematic diagram of a user equipment (UE) of the communication system shown in FIG. 2;

FIG. 6 is a schematic diagram showing a communication system 100 shown in FIG. 2 using hierarchical beam-spot deployment, according to some embodiments of this disclosure;

FIG. 7 is a schematic diagram showing a plurality of bandwidth parts (BWPs) used by the communication system 100 shown in FIG. 6, according to some embodiments of this disclosure;

FIG. 8 is a flowchart showing a beam-search procedure executed by a UE of the communication system 100 shown in FIG. 6, according to some embodiments of this disclosure;

FIG. 9 is a schematic diagram showing a communication system 100 shown in FIG. 2 using hierarchical beam-spot deployment, according to some embodiments of this disclosure, wherein the coverage area of a lower-level beam is divided into a plurality of partitions, each corresponding to a higher-level beam;

FIG. 10 is a schematic diagram showing a plurality of BWPs used by the communication system 100 shown in FIG. 6, according to some other embodiments of this disclosure;

FIG. 11 is a schematic diagram showing the communication system 100 shown in FIG. 6 in the form of a multi-layer system comprising a plurality of terrestrial and/or non-terrestrial subsystems, according to some other embodiments of this disclosure; and

FIG. 12 is a schematic diagram showing the communication system 100 shown in FIG. 6 in the form of a multi-layer system comprising a plurality of terrestrial and/or non-terrestrial subsystems, according to yet some other embodiments of this disclosure.

### DETAILED DESCRIPTION OF ILLUSTRATIVE EMBODIMENTS

### A. System Structure

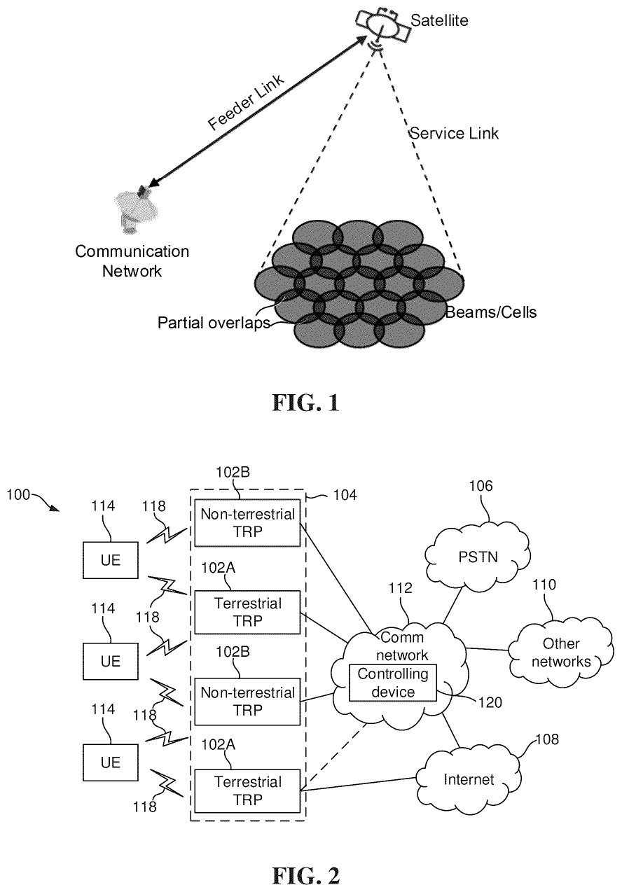

Turning now to FIG. 2, a communication system is shown and is generally identified using reference numeral 100. As shown, the communication system 100 comprises a plurality of transmit-receive points (TRPs) 102. Herein, a TRP 102 may also be referred to as a communication node, a gNodeB (next generation NodeB, also called a “gigabit” NodeB or a “gNB”), a base station, an access point, and/or the like, and may comprise a plurality of terrestrial TRPs 102A and a plurality of non-terrestrial TRPs 102B.

The TRPs 102 generally forms one or more radio access networks (RANs) in communication with a plurality of user equipments (UEs) 114 for providing wireless communication services to the UEs 114 such that the UEs 114 may access one or more public switched telephone networks (PSTNs) 106, the Internet 108, and other networks 110 via a communication network 112 to make phone calls (to, for example, other UEs 114, landline phones (not shown), and/or the like), exchanging data (for example, sending/receiving emails, sending/receiving instant messages, and/or the like), accessing contents (such as text content, audio content, and/or video content), and/or the like.

Each RAN 104 may correspond to one or more serving cells (or simply “cells”; also identified using reference numeral 104). Herein, a serving cell is a combination of downlink and optionally uplink resources. The serving cell resources can correspond to one downlink (DL) carrier frequency and optionally one uplink (UL) carrier frequency in case of a single-carrier serving cell or multiple DL carrier frequencies and optionally multiple UL carrier frequencies in case of a multi-carrier serving cell. The linking between the carrier frequency of the downlink resources and the carrier frequency of the uplink resources is indicated in the system information transmitted on the downlink resources. A serving cell may also be defined as a radio network object that may be uniquely identified by a UE 114 from a cell identification (that is physical cell identifier (ID)) that is broadcasted (via a synchronization signal and physical broadcast channel (PBCH) block (SSB)) over a geographical area from one or more TRPs 102. A cell may be in either the frequency division duplex (FDD) mode or the time division duplex (TDD) mode.

The PSTN 106 may include circuit switched telephone networks for providing plain old telephone service (POTS). The Internet 108 may include a network of computers and subnets (intranets) or both, and incorporate protocols, such as IP, TCP, UDP, and/or the like.

The communication network 112 comprises one or more controlling devices 120 in communication with the TRPs 102 to provide various services such as voice, data, and other services to the UEs 114. The one or more controlling devices 120 of the communication network 112 may also serve as a gateway access between (i) the TRPs 102 or UEs 114 or both, and (ii) other networks (such as the PSTN 106, the Internet 108, and the other networks 110).

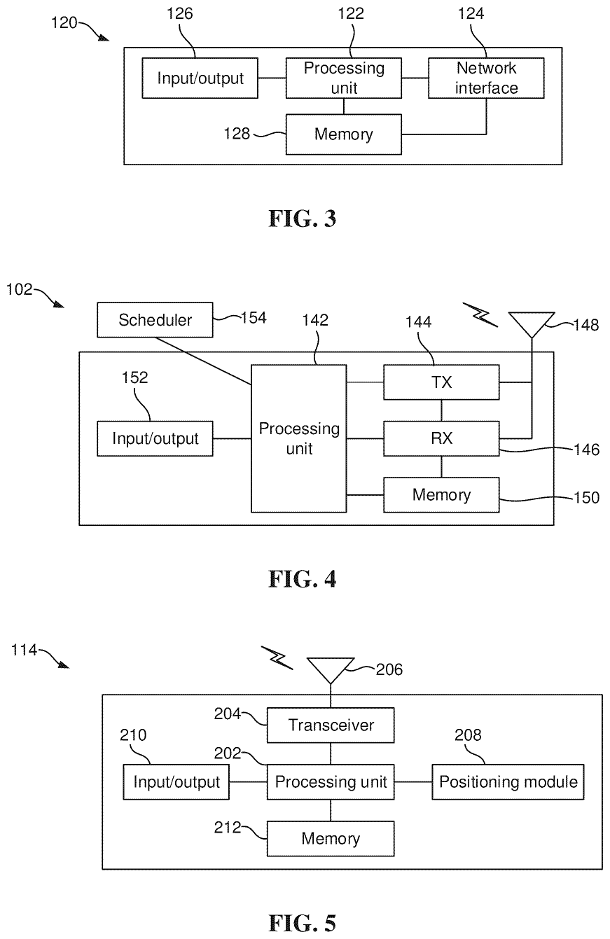

FIG. 3 is a simplified schematic diagram of the controlling device 120. As shown, the controlling device 120 comprises at least one processing unit 122 (also denoted “processor”), at least one network interface 124, one or more input/output components or interfaces 126, and at least one memory 128 (also denoted “storage device” hereinafter).

The processing unit 122 is configured for performing various processing operations and may comprise a microprocessor, a microcontroller, a digital signal processor, a field programmable gate array (FPGA), an application specific integrated circuit (ASIC), and/or the like.

The network interface 124 comprises a circuitry for directly or indirectly (that, via one or more intermediate devices) communicating with other devices such as the TRPs 102, the PSTN 106, the Internet 108, and other networks 110 using suitable wired or wireless communication technologies and suitable protocols.

Each input/output component 126 enables interaction with a user or other devices in the communication system 100. Each input/output device 126 may comprise any suitable structure for providing information to or receiving information from a user and may be, for example, a speaker, a microphone, a keypad, a keyboard, a display, a touch screen, and/or the like.

Each memory 128 may comprise any suitable volatile and/or non-volatile storage and retrieval components such as random access memory (RAM), read only memory (ROM), hard disk, optical disc, subscriber identity module (SIM) card, solid-state memory modules, memory stick, secure digital (SD) memory card, and/or the like. The memory 128 may be used for storing instructions executable by the processing unit 122 and data used, generated, or collected by the processing unit 122 and/or the network interface 124. For example, the memory 126 may store software instructions or modules executable by the processing unit 122 for implementing some or all of the functionalities and/or embodiments of the controlling device 120 described herein. The memory 126 may also store coverage information of the TRPs 102 (described in more detail later) in, for example, a database thereof.

Referring back to FIG. 2, the TRPs 102 comprise a plurality of terrestrial TRPs 102A and a plurality of non-terrestrial TRPs 102B. Herein, a terrestrial TRP 102A is generally deployed on the ground (including on ground-based infrastructures such as buildings, towers, and/or the like). The terrestrial TRP 102A may typically comprise a plurality of components such as one or more transmitters and receivers, one or more base station controllers (BSCs), radio network controllers (RNCs), relay nodes, elements, and/or the like. Each terrestrial TRP 102A (or more specifically the base station thereof) transmits and/or receives wireless signals within a particular geographic region or area (that is, a “coverage area” of a serving cell), which may be further partitioned into a plurality of sectors, and a terrestrial TRP 102A may, for example, employ multiple transceivers to provide service to multiple sectors. In some embodiments, there may be established pico or femto cells where the radio access technology supports such. In some embodiments, multiple transceivers may be used for each cell, for example using multiple-input multiple-output (MIMO) technology.

As those skilled in the art understand, cellular coverage (that is, the coverage of the terrestrial TRPs 102A) typically varies depending on the regions. For example, cellular coverage is typically strong and widely available in regions with dense cellular infrastructure deployment; examples of such regions may be urban regions with high population density where carriers are more willing to deploy more cellular infrastructure. On the other hand, cellular coverage may be sparse and poorly available in regions with sparse cellular infrastructure deployment; examples of such regions may be rural or remote regions with low population density where carriers are less motivated to deploy cellular infrastructure.

On the other hand, a non-terrestrial TRP 102B is a TRP generally deployed above ground or in the space such as a communication satellite or a high altitude platform stations (HAPS) (for example, a drone, a balloon, an airship, an aircraft, or the like). In various embodiments, a non-terrestrial TRP 102B may be permanently or semi-permanently deployed (such as a non-terrestrial TRP 102B in the form of a communication satellite, a communication balloon or airship anchored at a fixed location, or the like), or may be temporarily deployed (for example, a non-terrestrial TRP 102B in the form of a drone, a balloon, or an airship temporarily deployed about a location) for supporting an anticipated intensive-communication event such as a concert, a game, or the like, wherein the deployment of the non-terrestrial TRP 102B may be cancelled after the event.

The terrestrial TRP 102A and non-terrestrial TRP 102B may have a similar structure although they may be different in some aspects such as their communication bandwidths, communication technologies, protocols, and/or the like.

FIG. 4 is a simplified schematic diagram of a TRP 102. As shown, the TRP 102 comprises at least one processing unit 142 (also called “processor”), at least one transmitter 144, at least one receiver 146, one or more antennas 148, at least one memory 150, and one or more input/output components or interfaces 152. A scheduler 154 may be coupled to the processing unit 142. The scheduler 154 may be included within or operated separately from the TRP 102. In this disclosure, the TRP 102 may be a base station. The functions of the TRP 102 may be located in different logical or physical nodes, such as some functions are located in the centralized unit (CU) and some other functions are located in the distributed unit (DU). The functions of the TRP 102 may be split into control plane function and user plane function.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like.

Each transmitter 144 may comprise any suitable structure for generating signals for wireless transmission to one or more UEs 114 or other devices. Each receiver 146 may comprise any suitable structure for processing signals received wirelessly from one or more UEs 114 or other devices. Although shown as separate components, at least one transmitter 144 and at least one receiver 146 may be integrated and implemented as a transceiver. Each antenna 148 may comprise any suitable structure for transmitting and/or receiving wireless signals. Although a common antenna 148 is shown in FIG. 4 as being coupled to both the transmitter 144 and the receiver 146, one or more antennas 148 may be coupled to the transmitter 144, and one or more separate antennas 148 may be coupled to the receiver 146.

Each memory 150 may comprise any suitable volatile and/or non-volatile storage and retrieval components such as RAM, ROM, hard disk, optical disc, SIM card, solid-state memory modules, memory stick, SD memory card, and/or the like. The memory 150 may be used for storing instructions executable by the processing unit 142 and data used, generated, or collected by the processing unit 142. For example, the memory 150 may store software instructions or modules executable by the processing unit 142 for implementing some or all of the functionalities and/or embodiments of the TRP 102 described herein.

Each input/output component 152 enables interaction with a user or other devices in the system 100. Each input/output device 152 may comprise any suitable structure for providing information to or receiving information from a user and may be, for example, a speaker, a microphone, a keypad, a keyboard, a display, a touch screen, a network communication interface, and/or the like.

Referring back to FIG. 2, the TRPs 102 may communicate with the UEs 114 over one or more air interfaces 118 using any suitable wireless communication links such as radio frequency (RF), microwave, infrared (IR), and/or the like. The air interfaces 118 may utilize any suitable channel access methods such as time division multiple access (TDMA), frequency division multiple access (FDMA), orthogonal FDMA (OFDMA), single-carrier FDMA (SC-FDMA), code division multiple access (CDMA), wideband CDMA (WCDMA), and/or the like.

The air interfaces 118 may use any suitable radio access technologies such as universal mobile telecommunication system (UMTS), high speed packet access (HSPA), HSPA+ (optionally including high speed downlink packet access (HSDPA), high-speed uplink packet access (HSUPA), or both), Long-Term Evolution (LTE), LTE-A, LTE-B, IEEE 802.11, 802.15, 802.16, CDMA2000, CDMA2000 1X, CDMA2000 EV-DO, IS-2000, IS-95, IS-856, global system for mobile communications (GSM), enhanced data rates for GSM evolution (EDGE), GSM EDGE radio access network (GERAN), 5G New Radio (NR), standard or non-standard satellite internet access technologies, and/or the like. Moreover, the communication system 100 may use multiple channel access functionality. Of course, other multiple access schemes and wireless protocols may be used.

Herein, a UE 114 generally refers to a wireless device that may join the communication system 100 via a joint initial-access procedure (described in more detail later). In various embodiments, a UE 114 may be a wireless device used by a human or user (such as a smartphone, a cellphone, a personal digital assistant (PDA), a laptop, a computer, a tablet, a smart watch, a consumer electronics device, and/or the like. A UE 114 may alternatively be a wireless sensor, an Internet-of-things (IoT) device, a robot, a shopping cart, a vehicle, a smart TV, a smart appliance, or the like. Depending on the implementation, the UE 114 may be movable autonomously or under the direct or remote control of a human, or may be positioned at a fixed position. In some embodiments, a UE 114 may be a network device (such as a TRP 102, a wireless transmit/receive unit (WTRU), a mobile station, a fixed or mobile subscriber unit, a machine type communication (MTC) device, a device of the communication network 112, or the like) which is considered as a UE when it is powered on and joins the communication system 100 via the joint initial-access procedure; and then acts as a network device after the joint initial-access procedure is completed). In some embodiments, the UEs 114 may be multimode devices capable of operation according to multiple radio access technologies and incorporate multiple transceivers necessary to support such.

FIG. 5 is a simplified schematic diagram of a UE 114. As shown, the UE 114 comprises at least one processing unit 202 (also called “processor”), at least one transceiver 204, at least one antenna or network interface controller (NIC) 206, one or more input/output components 210, and at least one memory 212. The UE 114 may further comprising at least one positioning module 208.

The processing unit 202 is configured for performing various processing operations such as signal coding, data processing, power control, input/output processing, or any other functionalities to enable the UE 114 to join the communication system 100 and operate therein. The processing unit 202 may also be configured to implement some or all of the functionalities and/or embodiments of the UE 114 described in this disclosure. The processing unit 202 may comprise a microprocessor, a microcontroller, a digital signal processor, a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like.

The at least one transceiver 204 may be configured for modulating data or other content for transmission by the at least one antenna 206. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning anchors. The positioning module 208 may use the transceiver 204 and antenna 206 for communicating with the positioning anchors, or may comprise separate transceiver and antenna for communicating with the positioning anchors. In some embodiments, the positioning anchors may be positioning devices such as navigation satellites and/or HAPS separated from the non-terrestrial TRPs 102B. For example, the navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning anchors may be devices (for example, navigation satellites and/or HAPS) acting as both positioning anchors for providing positioning reference signals and as non-terrestrial TRPs 102B.

The one or more input/output components 210 is configured for interaction with a user or other devices in the system 100. Each input/output component 210 may comprise any suitable structure for providing information to or receiving information from a user and may be, for example, a speaker, a microphone, a keypad, a keyboard, a display, a touch screen, a network communication interface, and/or the like.

The at least one memory 212 is configured for storing instructions executable by the processing unit 202 and data used, generated, or collected by the processing unit 202. For example, the memory 212 may store software instructions or modules executable by the processing unit 202 for implementing some or all of the functionalities and/or embodiments of the UE 114 described herein. Each memory 212 may comprise any suitable volatile and/or non-volatile storage and retrieval components such as AM, ROM, hard disk, optical disc, SIM card, solid-state memory modules, memory stick, SD memory card, and/or the like.

For ease of description, in the following, a communication system 100 having one or more terrestrial TRPs 102A and no non-terrestrial TRPs 102B is denoted a terrestrial network (TN) system, and a communication system 100 having one or more non-terrestrial TRPs 102B is denoted a non-terrestrial network (NTN) system. Those skilled in the art will appreciate that a NTN system 100 may also comprise one or more terrestrial TRPs 102A. Moreover, while a NTN system 100 is described as an example in the following description, those skilled in the art will appreciate that the methods describe below may also be used for TN systems, and/or the terrestrial TRPs 102A of NTN systems, and/or any radio-access architectures in which beam-based communication is supported or used, especially when there is an issue with the coverage, or where the overhead for reference-signal transmission should be limited.

### B. Communication System with Hierarchical Beam Deployment

As described above, conventional NTN systems use a regular beam-layout pattern to transmit both SSB and data channel signals. However, such a regular beam-layout pattern may result in non-efficient utilization of the resources.

In prior art, 3GPP Specification #38.821 uses NR beam management for NTN, wherein a wide anchor signal beam transmitted over a default bandwidth part (BWP; a BWP is a part or all of the system band width of the serving cell, or is a part or all of the carrier band width of the serving cell) (for example, BWP0) is used by all UEs 114 for synchronization and connection to the serving cell 104. After a connection is established through the anchor beam, narrow beam spots (that is, narrower than the anchor beam) are used for data transmission, possibly over different BWPs. Such narrow beam spots may be indicated to the UE 114 by channel-state-information reference signal (CSI-RS). The UE 114 then needs to send certain measurement reports to allow the RAN 104 to select the best beam spot for data transmission. However, such a method may result in an incredible overhead of reference signal and measurement report transmissions over the anchor beam resources. Moreover, the anchor beam channels may be congested when many UEs 114 try to establish a connection through the same resources.

In integrated satellites and terrestrial networks, a beam management method may be used, wherein different subsystems or RANs with different TRP types, and possibly different access technologies, are integrated to facilitate access and to enhance coverage for the UEs 114. In this method, different priority levels are assigned to the nodes of different sub-systems. Starting with the subsystems of highest priority, the UE 114 detects SSBs and then connects to the highest priority subsystem. Then, the subsystem with a higher priority provides the UE 114 with certain information related to lower priority sub-systems (such as indicating the access technology, the SSB frequency resources, and the like) to facilitate access to lower priority sub-systems.

Such a priority-based access mechanism has several limitations in supporting access to a set of hierarchical beam spots. For example, it is unclear how to assign priority levels to different beams. If one assigns the highest priority to the narrowest beams, each UE 114 may need to check several potential SSB resources before successfully detecting and connecting through one SSB beam, as there may be no beam spot coverage except for the anchor beam at most parts of the coverage area. Moreover, this method may not have the flexibility to adaptively change the access parameters for the beam spots, because the UEs 114 expect to observe SSBs according to a default pattern. On the other hand, by assigning a higher priority to the anchor beams, the anchor beam may facilitate access to the beam spots. However, the anchor beam may be congested as all UEs 114 may attempt an initial access through the anchor beam resources.

The main issue with the hierarchical beam management method in NR is that it may result in congestion over the anchor beam channels. One reason is that, while all UEs 114 strive to establish a connection through the anchor beam resources, such resources are not reused over the anchor beam's wide coverage area. Moreover, since the gain and link budget of the anchor beam are limited compared to the beam spots, the bandwidth efficiency of the anchor beam is limited.

With an extensive deployment of IoT and machine-type devices, there may be a surge in the number of connected UEs 114, especially for next-generation NTNs that provide coverage for urban and suburban areas. Accordingly, there may be a surge in the anchor-beam traffic demand especially in the presence of IoT devices which may adopt short data transmission methods over the anchor beam resources.

In the following, a hierarchical beam-deployment method and a corresponding beam-search method are disclosed, which may be used by the communication system 100 to meet the spatiotemporal variations in user-traffic demands for the efficient resource utilizations.

By using the hierarchical beam-deployment method, a RAN 104 transmits SSB beams in a hierarchical fashion, wherein beams at a higher hierarchical level (denoted “higher-level” beams) typically have narrower beam-width than beams at a lower hierarchical level (denoted “lower-level” beams). It shall be noted that a higher-level beam may have same beam-width with a lower-level beams, or a higher-level beam may have wider beam-width than a lower-level beam. This disclosure does not limit it. In summary, the hierarchical structure of different beams may be characterized as follows: a basic information (for example, time-frequency resources, beam footprint, beamwidth or half-power beamwidth, beam angular information such as zenith/elevation angle and/or azimuth angle, and/or the like) of a higher-level beam is signaled over a lower-level beam, and thus the two beams may be considered as being associated with different beam hierarchy levels.

In some embodiments, one or more lower-level beams may be used for providing coverage for sparse user-traffic demands, and one or more higher-level, narrower beams may be used for providing coverage for hot-spot regions.

The beams of different hierarchy levels are transmitted over different resources. Particularly, the beams of lowest hierarchy level (denoted “umbrella beams”) are transmitted over a predefined or default BWP (such as BWP0, which is known to all UEs 114) configured or pre-configured by the serving cell 104 and is known to each UE 114 in the radio resource control (RRC) IDLE mode before it connects to the serving cell 104, that is, before the UE 114 transitions into RRC CONNECTED state, while the beams of higher hierarchy levels are adaptively allocated with different resources (which may also be configured or pre-configured by the serving cell 104). The SSB of a beam at each hierarchy level indicates whether there exist any higher-level beams within its coverage area. The system information of lower-level beams provides certain configurations (for example, a reference to the resources where SSBs are transmitted) related to the higher-level beams therewithin.

By using the beam-search method, a UE 114 starts with detecting SSBs of the lowest hierarchy level. For example, the lowest-level SSBs may be sent on the SSB raster (such as the global synchronization raster channel (GSCN)) which is known and common for all UEs. Then, the UE 114 may use conventional blind detection to detect the lowest-level SSBs. On the other hand, SSBs of higher levels may be transmitted outside the SSB raster and hence may only be detectable if the UE 114 has already obtained the relevant information from the lower-level SSBs.

After detecting the lowest-level SSBs, the UE 114 keeps searching for higher-level SSBs until it detects the highest-level SSBs transmitted to its location, or the UE 114 keeps searching for higher-level SSBs until it detects a pre-configured number of higher-level SSBs. With the measurements and other information of the detected beams of various hierarchy levels, the UE 114 may follow certain (pre-)configured criteria or conditions to select the best SSB of the highest hierarchy level from the detected beams, and use it to establish a connection with the serving cell 104. The system information related to the higher-level beams may further facilitate the beam search, for example, by providing information or configurations related to the coverage of the higher-level beams. Moreover, the flexibility that is provided to (re-)configure the access parameters for the higher-level beams may be used to opportunistically save energy (for example, by configuring longer SSB periodicities, adaptively activating/deactivating different subset of SSBs among the configured beam spots, and/or the like).

By using the hierarchical beam-deployment method and the beam-search method disclosed herein, the communication system 100 disclosed herein may support various user-traffic demands with a lower overhead of reference signal transmission and energy consumption, compared to the conventional beam layout wherein narrower beams are uniformly deployed across the same coverage area.

The communication system 100 disclosed herein efficiently reuses the spectral resources among the beams while avoiding congestion over lower-level beams (which are more commonly available to various UEs 114 than higher-level beams). Towards this end, the higher-level beams (such as the hot-spot beams) may be associated with separate reference signals and control channel resources (such as SSBs, random access channel occasions (ROs), physical random access channel (PRACH), and different search regions). Moreover, a UE 114 in a hot-spot region may try to use higher-level beam resource rather than simply getting access through lower-level beam resources. Thus, the hierarchical beam-deployment method and the beam-search method disclosed herein provide the flexibility to adaptively configure the access parameters and the coverage area for higher-level beams, thereby saving energy and optimizing the beam deployment in an opportunistic fashion.

The hierarchical beam-deployment method may be used by any TRPs 102 including terrestrial and non-terrestrial TRPs. Particularly, the hierarchical beam-deployment method enables tailoring of the beam deployment to the user-traffic demand, thus enhancing the resource utilization, while reducing the complexity of beam search for the user. The proposed method can be further extended to support integrated access to different layers in the presence of multiple terrestrial and non-terrestrial subsystems.

In some examples described below, the hierarchical beam-deployment method is used by non-terrestrial TRPs such as HAPS, wherein a variety of beams with different beam-width may be at least partially deployed with the beam footprint radius ranging from a few hundred meters (sufficient for covering a hot-spot region) to tens of kilometers. As those skilled in the art will appreciate, the coverage is usually not an issue for HAPS regardless of the beam-width because of the line-of-sight (LoS) configuration and close distance to the ground compared to satellites. Thus, the hierarchical beam deployment disclosed herein is useful to provide coverage to both the rural environment and (sub-)urban regions while the beams are adaptively deployed for different regions depending on the UE demands.

Those skilled in the art will appreciate that, in some embodiments, the hierarchical beam-deployment method may also be used by other non-terrestrial TRPs such as satellites, and/or terrestrial TRPs.

FIG. 6 shows a communication system 100 using hierarchical beam-spot deployment for meeting the spatiotemporally varying user-traffic demand with a finite number of beams deployed across a service area 300, wherein each beam has a coverage area on the ground. Herein, the term “service area” refers to an area on or near the ground wherein the beams are deployed therein for providing communication services to the UEs therewithin such as UEs carried by users or other objects on the ground, UEs in vessels on water, UEs in the air (such as in drones, airplanes, and/or the like) above the ground, and/or the like. The term “coverage area”, “footprint”, and “coverage footprint” may be used interchangeably and refer to an area on or near the ground wherein the signal beam or reference/synchronization signal associated with the signal beam can be detected with a reference signal received power above a certain threshold. Thus, the service area is generally the ensemble of the footprints or coverage areas of all beams.

As shown, a RAN 104 (such as a non-terrestrial TRP 102B thereof) transmits a plurality of beams 302 to 306 to the service area 300. The beams 302 to 306 are categorized or otherwise organized into different beam-level hierarchies. The beam size (or the beam width) of a higher-level beam is smaller (or narrower) than that of a lower-level beam. A higher-level beam is at least partially deployed, contained, or otherwise confined within the coverage area of a lower-level beam (that is, the footprint of the higher-level beam at least partially overlaps with that of the lower-level beam), and the lower-level beam may serve as an anchor beam for the higher-level beam deployed therewithin. For ease of description, the terms “deployed”, “contained”, “confined”, and “overlapping” used hereinafter generally refer to “at least partially deployed”, “at least partially contained”, “at least partially confined”, and “at least partially overlapping”, respectively.

In the example shown in FIG. 6, the beams 302 to 306 are organized into one or more first-level beams 302 (also denoted “umbrella beams”) to provide general coverage of the service area 300, for example, to provide coverage for sparse users or UEs 114 for which no other beam is deployed (wherein for ease of illustration, a single umbrella beam 302 is shown in FIG. 6), one or more second-level beams 304 overlapping the umbrella beam 302 (that is, deployed or otherwise confined within the coverage of the umbrella beam 302), and one or more third-level, narrow beams 306 overlapping one or more second-level beams 304 (that is, deployed or otherwise confined within the coverage of the second-level beams 304) to provide coverage for hot-spot regions of the service area 300. The second-level and third-level beams 304 and 306 may be adaptively deployed in the service area 300 based on the user-traffic demand. As defined in subsection C, a lower-level beam is an anchor beam of the higher-level beams confined therewith, and a higher-level beam is a beam spot of its anchor beam.

In order to efficiently utilize the resources of such beams, the UEs 114 at any location of the service area 300 needs to distinguish beams of different hierarchy levels and connects to the beam of the highest hierarchy level. For this purpose, in these embodiments, the beams 302 to 306 of different hierarchy levels are transmitted over different resources with the SSBs of the beams of the lowest hierarchy level transmitted in a known manner such as a default BWP, a default carrier frequency, a default frequency range, a SSB raster such as GSCN (wherein the synchronization raster indicates the frequency positions of the SSB the UE 114 may use to acquire system acquisition in the absence of explicit signaling of the SSB position), or the like. While “BWP” may have a specific meaning in NR and is normally configured to the UE 114 after initial access and connecting to the serving cell), the default BWP (also called “initial BWP”) is determined by the UE 114 after detecting a cell-defining SSB. Thus, the term “default BWP” used herein may be broadly understood as a frequency position or a set of frequency positions with a carrier frequency or band where a UE 114 may blindly detect the SSBs.

For example, the SSBs of umbrella beams 302 (which has the lowest hierarchy level) are transmitted in a default BWP such as BWP0, while the higher-level beams (for example, the second-level beams 304 and the third-level beams 306 shown in FIG. 6) are flexibly allocated in other BWP(s). Note that all the beams of different hierarchy levels may be transmitted via same BWP, for example, the BWP0, and in this case, different beams may be transmitted over different time and/or frequency resources of the BWP. Note also that one BWP may carry, comprise, or otherwise be configured with one or more beams of different hierarchy levels. For example, BWP0 may carry the lowest-level beam, and BWP1 may carry the second-level beam and the third-level beams with different time and/or frequency resources. There is no limitation in present disclosure. In this disclosure, the expression that the BWP comprises or has a beam means the BWP carries or is configured, or is associated with a beam, signal beam, or beamforming angular direction of a beam, or a signal beam transmitted on the resources within the BWP.

In these embodiments, the SSBs of the beam at each hierarchy level comprises a flag bit for indicating if there are any higher-level beams within the coverage of the beam of the current hierarchy level. Also using FIG. 6 as an example, the RAN 104 transmits a first-level umbrella beam 302 or B₀ to a service area 300, a plurality of second-level beams 304 (including B₁, B₂, B₃, and B₄) within the area of the umbrella beam B₀, and a plurality of third-level beam spots 306 within the areas of their second-level anchor beams B₁, B₃, and B₄. For example, the beam spots B_{1,1}, B_{1,2}, and B_{1,3} are within the area of their anchor beam B₁.

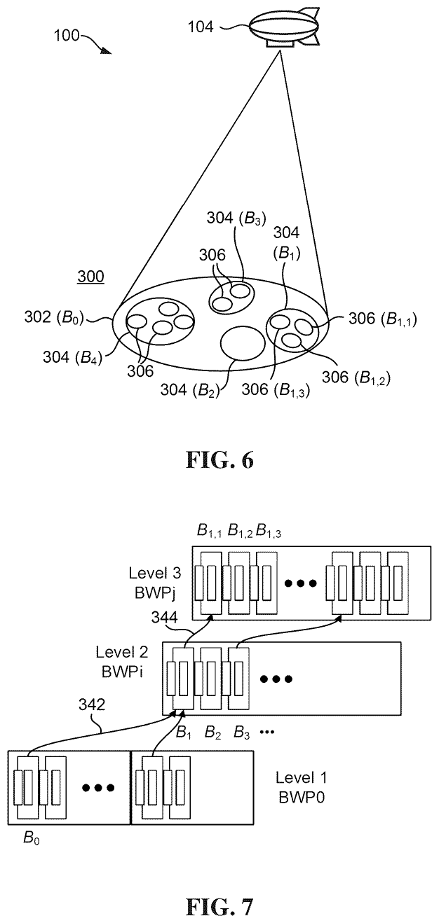

FIG. 7 is a schematic diagram showing a plurality of BWPs. According to a predefined configuration, the SSB of the first-level umbrella beam B₀ (which is also denoted “B₀” in FIG. 7) is transmitted in the default, level-1 BWP (for example, BWP0), the SSBs of the second-level beams B₁, B₂, B₃, and B₄ (which are also denoted “B₁”, “B₂”, “B₃”, and “B₄” in FIG. 7, respectively) are transmitted in the i-th BWP (denoted BWPi), and the SSBs of the third-level beams are transmitted in the j-th BWP (denoted BWPj).

The flag bit of SSB B₀ is TRUE (illustrated by the arrow 342), indicating that there are higher-level beams (that is, the second-level beams) within the coverage of the first-level umbrella beam B₀. The flag bit of SSB B₁ is TRUE (illustrated by the arrow 344), indicating that there are higher-level beams (that is, the third-level beams) within the coverage of the second-level beam B₁. The flag bit of each of the SSBs B_{1,1}, B_{1,2}, and B_{1,3} are FALSE, indicating that no higher beams are within the coverage of the corresponding third-level beams B_{1,1}, B_{1,2}, or B_{1,3}.

FIG. 8 is a flowchart showing a beam-search procedure 400 executed by a UE 114.

After the beam-search procedure 400 starts (step 402), the UE 114 starts the beam search by looking for SSBs in the default BWP (corresponding to SSBs of the umbrella beams 302 at the lowest hierarchy level. In other words, the UE 114 sets the current BWP as the default BWP at step 404 (that is, the current hierarchy level is the lowest hierarchy level), and detects SSBs therein at step 406.

At step 408, the UE 114 checks the flag bit of the detected SSB to determine if there is are any higher-level beams.

If the flag bit is TRUE indicating that there are any higher-level beams within the coverage of the beam of the current hierarchy level, the UE 114 finds a reference to the search region for the higher hierarchy level by reading the system information block (SIB) of the currently detected beam (step 410). As will be described in more detail below, in various embodiments, such a search region may be the same or a higher-level BWP where the higher-level SSBs are transmitted. The determined search region is then set as the current BWP and the beam-search procedure 400 goes back to step 406.

Thus, step 406 may be performed one or more times and one or more SSBs at one or more hierarchy levels may be detected.

If, at step 408, the flag bit is FALSE indicating that there are no higher-level beams within the coverage of the beam of the current hierarchy level, the UE 114 then selects a SSB or beam from all detected SSBs (which may be one or more SSBs at one or more hierarchy levels) based on (pre-)configured criteria (step 412). The beam-search procedure 400 then ends (step 414). The UE 114 may then report the selected SSB to the RAN 104, determine an initial uplink BWP and an initial downlink BWP based on the selected SSB, and perform an initial-access procedure based on the determined initial uplink and downlink BWPs.

Thus, by executing the beam-search procedure 400, the UE 114 keeps looking for higher-level SSBs until there is no narrower beam spot(s) within the coverage footprint of the already detected highest-level beam. Alternatively, the UE 114 may keep looking for higher-level SSBs until a pre-configured number of higher-level beams have been detected. After that, the UE 114 selects one beam among the detected SSBs based on certain (pre-)configured criteria.

After the UE 114 selects one beam, it may camp on the serving cell with the selected beam. Or it may initiate access procedure to the network, for example, the UE 114 may transmit a RRC connection request message to establish a RRC connection, a RRC connection re-establish request message to re-stablish the RRC connection, or a RRC connection resume request message to resume the RRC connection. Or it may initiate uplink data transmission directly (i.e., without transition to RRC active state firstly) in RRC idle state or in RRC inactive state.

In these embodiments, the criteria for beam selection at step 412 may be a constraint in terms of certain measurements, such as the reference-signal received powers (RSRPs) of detected SSBs. For example, at step 412, a UE 114 may select a beam or SSB of the highest hierarchy level with a RSRP greater than a threshold value, or a beam or SSB having the greatest RSRP. As another example, a UE 114 may select a beam or SSB from a plurality of detected SSBs if the RSRP of the SSB is greater than the RSRP of each of its higher-level beams by at least a threshold value (which may be predefined or may be customized).

In other embodiments, the UE 114 may use other metrics as the criteria for beam selection. For example, in some embodiments, the UE 114 may use the RSRPs of detected SSBs to estimate the distances between the UE 114 and the centers of the beams of the detected SSBs, and select a SSB of the shortest distance. Alternatively, if such distance information is provided through the SIB of the beams, the UE 114 may use the SIB to select a SSB of the shortest distance.

In some embodiments, the UE 114 may select the beams based on a certain probability which is adjusted based on the measurements/information that are gathered by the UE 114. The UE 114 may alternatively exclude some SSBs/beams based on certain constraints such as the UE's capabilities (for example, the maximum uplink power, antenna gain, and/or the like), and then select a SSB from the remaining subset of the beams based on a soft-decision/probabilistic metric. For example, a UE 114 with a limited transmission power may exclude from the detected SSBs some wide beams (wider than a threshold width), for which the UE's link budget is not sufficient, and then selects a SSB from the remaining beams by applying certain probabilities depending on the measurements and configurations.

In above embodiments, each SSB comprises a flag bit for indicating if there are any higher-level beams within the coverage of the beam of the current hierarchy level. The default BWP (such as BWP0) is known to all UEs 114, and the indices of other BWPs or search regions where the SSBs of the higher-level beams are transmitted are sent to the UEs 114 via the SIB. In some embodiments, the SIB in a certain BWP may further comprise a bitmap to indicate the pre-configured or otherwise predefined resources of a pre-configured or predefined beam pattern where the SSBs of the higher-level beams are transmitted. Such a bitmap may comprise, for example, one or more binary-ones (1′s) for indicating the pre-configured resources for transmitting the SSBs of the higher-level beams where the footprints of the higher-level beams are at least partially contained within or otherwise overlapped with the lower-level beam.

In some embodiments, the SIB of a lower-level beam may provide the UE 114 with different (re-)configurations related to its higher-level beam spots deployed or otherwise confined within the coverage thereof, and/or the access parameters of its higher-level beam spots. For example, the SIB of a second-level beam may further characterize the geographical coverage of its confined third-level beam spots. Particularly, the RAN 104 may explicitly inform the UE 114 about the coverage area of a third-level beam spot by signaling the UE 114 certain parameters such as the center point and beam-width of the coverage footprint of the beam spot. Such characterization may describe the actual area of coverage, or an area that is intended to be covered by a specific beam spot. Given the geographical coverage of each beam, the UE 114 then only needs to look into the beam spots which provide coverage at a certain location, thereby further simplifying the beam search for the UE 114.

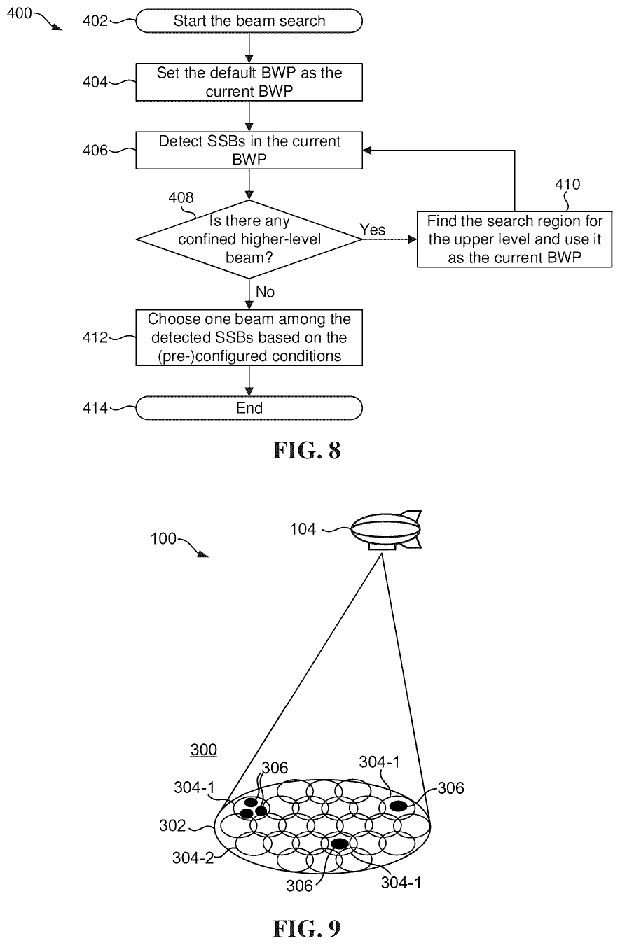

In some other embodiments, the RAN 104 may provide a rough estimate of the location of the confined higher-level beam spots by virtual partitioning of the footprint of their lower-level anchor beam. More specifically, the footprint of a lower-level anchor beam may be divided by the footprints of a plurality of N higher-level beams into a plurality of N partitions. Thus, the footprint of each higher-level beam corresponds to a partition of the lower-level beam. Such a virtual partitioning may be implemented by transmitting N higher-level beams to the N corresponding partitions of the lower-level anchor beam, and (pre-)configuring a function that maps the footprints of the partitions of the lower-level beam to a plurality of partition indices wherein each partition index may be, for example, an integer between one (1) and N, and is associated with the corresponding higher-level beam. FIG. 9 shows an example wherein the coverage area of a first-level umbrella beam 302 is divided (for example, uniformly divided) into a plurality of partitions, each corresponding to a second-level beam 304 (being 304-1 or 304-2). One or more third-level beams 306 may be deployed within some partitions 304-1.

With such a partitioning mapping, a bitmap may be included in the SIB of a lower-level anchor beam to indicate the presence of higher-level beams 306 in each partition 304. Alternatively, the SIB of a lower-level anchor beam (such as the umbrella beam in FIG. 9) may indicate the partition indices where its higher-level, narrower beam are deployed. A UE 114 with positioning capability may determine the partition 304 that the UE 114 is located. Then, the UE 114 may look into the higher-level beam spots 306 only if it is located within a partition 304-1 that has one or more higher-level beam spots 306 deployed therein.

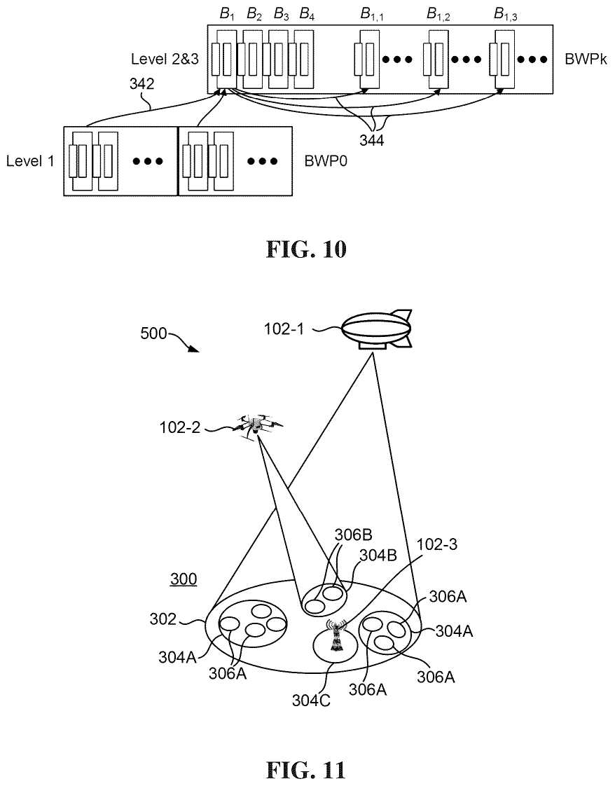

The SIB of the lower-level beam may adaptively (re-)configure certain access parameters for the higher-level beams. Examples of the access parameters which may be (re-)configured by the lower-level beam include SSB periodicity of the higher-level beams, and a time offset with respect to the lower-level beam. Such configurations may be used, for example, to time-share the same resource among different higher-level beams, thereby enhancing the resource utilization. Configuring the UE 114 with specific resources for SSBs over time, frequency, space, and/or code domains may further reduce the complexity of beam search for the UE 114. FIG. 10 is a schematic diagram showing the BWPs for the hierarchical beam deployment shown in FIG. 6. As shown in FIG. 10, the beams 304 and 306 of hierarchy levels 2 and 3 (that is, level-2 beams B₁, B₂, and B₃, and level-3 beams B_{1,1}, B_{1,2}, and B_{1,3}) are both transmitted over the same BWP (BWPk) but using different time resources. It also shows how configuring specific time offsets helps time-sharing the same resource among the second-level anchor beam B₁ and its confined beam spots B_{1,1}, B_{1,2}, and B_{1,3}.

Configuring a longer periodicity for SSBs may facilitate energy saving on the RAN side while reducing the overhead of reference signal transmission. By using the beam-search procedure 400, a UE 114 may detect and connect to higher-level beams having different access parameters, and in some embodiments to higher-level beams having adaptively changing access parameters.

In some embodiments, a lower-level beam may adaptively indicate the activation and/or deactivation of different subsets of higher-level SSBs/beams. For example, given a set of already configured beam spots 306 within their anchor beam 304, the anchor beam 304 may indicate in its system information which beams/SSBs 306 are active or inactive from one time-frame (for example, every 20 milliseconds (msec)) to the next time-frame. Such information may be indicated with a bitmap which, for example, identifies the subset of active beams by one or more binary-ones (1's) and identifies the subset of inactive beams by one or more binary-zeros (0's). For example, an anchor beam 304 may indicate which subset of its beam spots 306 that are configured by virtual partitioning of the footprint thereof (see FIG. 9) are active during each time-frame. Then, the UE 114 may exclude deactivated or inactive beams from its beam search and selection.

This method may be used to opportunistically save energy on the RAN side based on the traffic conditions of the higher-level beams 306, and/or to adaptively manage the inter-beam interference. The indication for activating/deactivating transmission of SSBs is also useful to transmit higher-level SSBs in an aperiodic fashion, thereby reducing the signaling overhead while enhancing the resource utilization by exploiting this flexibility. Indication of activating/deactivating the higher-level beams (such as beams 306) may be used in turn by the UEs 114 to switch between the lower-level beam and the higher-level beams therewith (such as between the second-level anchor beam 304 and its beam spots 306 therewithin). Moreover, in some embodiments where the UEs 114 are IoT devices, the IoT devices 114 may use such indications to adaptively adjust their sleep times.

FIG. 11 is a schematic diagram showing an exemplary multi-layer system 500 comprising a plurality of terrestrial and/or non-terrestrial TRPs 102-1 to 102-3 (collectively identified as 102). In this example, the 102-1 is a non-terrestrial TRP using HAPS, the TRP 102-2 is a non-terrestrial TRP using drones, and the TRP 102-3 is a terrestrial TRP. Each TRP 102 transmits a layer of one or more beams.

In some embodiments, the hierarchical beam-deployment method and beam-search method 400 may be used in multi-layer systems such as the multi-layer system 500 shown in FIG. 11 for coordinated access to different layers. In these embodiments, the beams of various layers are arranged according to above-described hierarchical beam deployment. A layer may have beams in one or more hierarchy levels.

For example, the beams of the HAPS TRP 102-1 may form a HAPS layer comprising a first-level umbrella beam 302, a plurality of second-level beams 304A within the umbrella beam 302, and a plurality of third-level beams 306A in some second-level beams 304A. The beams of the drone TRP 102-2 may form a drone layer comprising a second-level beam 304B within the umbrella beam 302 transmitted by the HAPS layer 102-1, and a plurality of third-level beams 306B within the second-level beam 304B. The terrestrial TRP 102-3 may form a terrestrial layer transmitting a second-level beam 304C within the umbrella beam 302 transmitted by the HAPS layer 102-1.

To efficiently utilize the resources in such a multi-layer system 500, it may be important to balance the load across the TRPs 102-1 to 102-3 of different layers. Consequently, the UE 114 should not simply get access through the first SSB/beam it detects. Rather, in these embodiments, one or more beams (transmitted by one or more of the layers 102) may be used as umbrella beams 302 by transmitting SSBs over a default BWP, for coordinating access to other beams by adaptively (re-)configuring certain access parameters. Particularly, each lower-level beam (such as the umbrella beam 302) indicates if there exist any higher-level beams within its coverage area, and whether the higher-level beams belong to the same or different layers. In some embodiment, the lower-level beams may characterize the coverage area of the higher-level beams with the indication of their layers and the indication of their activities. The access parameters (such as SSB periodicity) and other configurations such as the hierarchy level of each node/layer may be adaptively changing. In these embodiments, the UEs 114 are (pre-)configured with certain criteria for selecting a higher-level beam of a different layer that the layer of the lower-level beam.

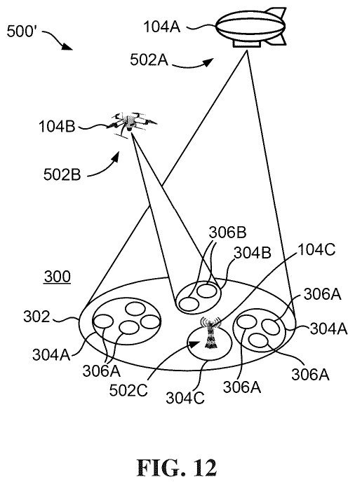

FIG. 12 is a schematic diagram showing an exemplary multi-layer system 500′ comprising a plurality of terrestrial and/or non-terrestrial subsystems 502A to 502C (collectively identified as 502). In this example, the subsystem 502A is a non-terrestrial subsystem using HAPS to form the serving cell 104A thereof, the subsystem 502A is a non-terrestrial subsystem using drones to form the serving cell 104B thereof, and the subsystem 502C is a terrestrial subsystem having terrestrial serving cell 104C. Each subsystem 502 transmits a layer of one or more beams.

In some embodiments, the hierarchical beam-deployment method and beam-search method 400 may be used in multi-layer systems such as the multi-layer system 500′ shown in FIG. 12 for coordinated access to different layers in a manner similar to that described above.

The hierarchical beam deployment and the beam-search procedure 400 disclosed herein reduce the complexity of beam search at the UE side (compared to sequential beam search over subsequent time resources), while ensuring the UE 114 to select a proper beam hierarchy level. The hierarchical beam deployment and the beam-search procedure 400 disclosed herein also enhance the resource utilization by adapting the higher-level beam deployment to the user-traffic demand. The hierarchical beam deployment and the beam-search procedure 400 disclosed herein may save energy and reduce the overhead for SSB transmission by exploiting the flexibility to (re-)configure the beam spot and SSB transmission pattern for higher beam hierarchy levels. Moreover, the hierarchical beam deployment and the beam-search procedure 400 disclosed herein may facilitate mobility as the UEs 114 may switch to a lower-level beam with known access parameters from a connected higher-level beam in case the connected higher-level beam fails.

In above embodiments, the SSBs of the beam at each hierarchy level comprises a flag bit for indicating if there are any higher-level beams within the coverage of the beam of the current hierarchy level. In some alternative embodiments, the SSBs of the beam at the highest hierarchy level may not comprise such a flag bit (that is, equivalent to have a flag bit of FALSE).

In above description, a hierarchical beam-deployment method and a corresponding beam-search method are disclosed, which allow deployment of a plurality of beams at a plurality of hierarchical levels, where a beam at a higher hierarchy level has a smaller or narrower beam-width than a beam at a lower hierarchy level, and may be deployed within the coverage area of the lower-level beam. In some embodiments, a flag bit in the SSB of each beam indicates the presence or absence of higher-level beams within the coverage area of the beam. The system information of each lower-level beam may comprise a reference to the SSBs of higher-level beams. The UEs 114 may be (pre-)configured with certain criteria for selection a beam from detected lower-and higher-level beams. Thus, the hierarchical beam-deployment method and beam-search method disclosed herein provide advantage of:
enhanced resource utilization with improved traffic management by tailoring the beam deployment to adapt to user-traffic demands;
reduced complexity of beam search at the UE side while ensuring the UE to select a proper beam hierarchy;
simplifying beam switching and reducing the chance of a beam failure by switching between beams of different hierarchy levels.

In some embodiments, the hierarchical beam-deployment method may characterize the coverage areas of higher-level beams via the system information of the corresponding lower-level beams, characterize the footprint of higher-level beams via the system information of the corresponding lower-level beams, and indicate the presence of higher-level beams through virtual partitioning of the coverage footprint of the lower-level beam, thereby simplifying beam search on the UE side. The system information may be conveyed by the SSB of the lower-level beam in the master information block (MIB) inside the PBCH, or as a remaining system information in a SIB message carried by a broadcast physical downlink shared channel (PDSCH) (that is, the physical downlink control channel (PDCCH) thereof is addressed by system-information radio network temporary identifier (SI-RNTI) in a manner such that the PDCCH is a broadcast PDSCH).

In some embodiments, a lower-level beam may adaptively (re-)configure certain access parameters for the higher-level beams deployed or otherwise confined therewithin by (re-)configuring the higher-level beams with longer SSB periodicities and/or adaptively activating/deactivating different subsets of SSBs, thereby providing great flexibility to (re-)configure the SSB transmission pattern for higher-level beams, reducing the overhead for reference signal transmission, and saving energy on the RAN side. The adaptive (re-)configuration also enables opportunistic energy saving and inter-beam interference management.

In some embodiments, the communication system 100 disclosed herein may be a multi-layer system using the hierarchical beam-deployment method and beam-search method disclosed herein for coordinating access to beams and/or nodes of different layers, thereby balancing the load across different layers and/or beams.

### C. Definitions of Some Technical Terms

Umbrella beam: The widest beam(s) which may contain one or more higher-level beams within its coverage footprint. A node (such as a HAPS or satellite) may deploy one or more umbrella beams.

Anchor beam: A beam containing one or more higher-level beams within its coverage footprint. An anchor beam may coordinate UE access to the beam spots therewithin.

Beam spot: A beam deployed within the coverage footprint of an anchor beam.

In above description, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

The term “comprise” is an open-ended term and means that, in addition to the set of recited elements or their equivalents in structure or function, there may be zero, one, or more other elements that may be counted into the set as needed or desired. The terms “have” and “include” are also open-ended terms unless the context suggests otherwise.

The expression such as “the BWP comprises/have one or more SSBs (or beams)” may be understood that the BWP may be configured with the one or more SSBs (or beams), the SSBs (or beams) may be transmitted over/via the BWP, or the BWP may be used for transmitting the one or more SSBs (or beams).

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

Although embodiments have been described above with reference to the accompanying drawings, those of skill in the art will appreciate that variations and modifications may be made without departing from the scope thereof as defined by the appended claims.

What is claimed is:

1. A method comprising:
transmitting a plurality of signal beams towards an area, each signal beam comprising a synchronization signal and physical broadcast channel (PBCH) block (SSB) and associated with a footprint, and each signal beam corresponding to a level of a plurality of levels; and
wherein the footprint of a lower-level beam of the plurality of signal beams at least partially encloses the footprint of a higher-level beam of the plurality of signal beams, and the SSB of the lower-level beam comprises a first indication of the higher-level beam.

2. The method of claim 1, wherein transmitting the plurality of signal beams towards the area comprises:
transmitting the plurality of SSBs via one or more bandwidth parts (BWPs); and
wherein each BWP is used for transmitting one or more SSBs of the plurality of SSBs.

3. The method of claim 1, wherein transmitting the plurality of signal beams towards the area comprises:
transmitting the SSB of a lowest-level beam of the plurality of signal beams via a predefined bandwidth part (BWP).

4. The method of claim 1, wherein transmitting the plurality of signal beams towards the area comprises:
transmitting system information of the lower-level beam, the system information of the lower-level beam comprising information related to the footprint of the higher-level beam, or a resource indication indicating a resource where the SSB of the higher-level beam is transmitted.

5. The method of claim 4, wherein the system information is comprised in a master information block (MIB) carried by a PBCH, or as remaining system information message carried by a physical downlink shared channel (PDSCH).

6. The method of claim 5, wherein the resource comprise a resource over one or more of time, frequency, space, or code domains.

7. The method of claim 4, wherein the system information of the lower-level beam comprises a first bitmap comprising the resource indication.

8. The method of claim 7, wherein the resource is a predefined resource; and
wherein the first bitmap comprises a binary-one as the resource indication indicating the predefined resource for transmitting the SSB of the higher-level beam.

9. The method of claim 4, wherein the system information of the lower-level beam comprises a second indication indicating whether the higher-level beam is active or inactive.

10. The method of claim 9, wherein the system information of the lower-level beam comprises a second bitmap comprising the second indication.

11. The method of claim 10, wherein the second indication is a binary bit of the second bitmap, where the second indication has a value of binary-one indicating the higher-level beam being active or has a value of binary-zero indicating the higher-level beam being inactive.

12. The method of claim 1, wherein transmitting the plurality of signal beams towards the area further comprises:
transmitting a third indication; and
wherein the third indication indicates that the footprint of the lower-level beam is divided by the footprints of a set of higher-level beams of the plurality of signal beams into a plurality of partitions.

13. The method of claim 1, wherein the plurality of signal beams are transmitted by a plurality of terrestrial or non-terrestrial transmit-receive points (TRPs) of a radio access network (RAN), or by a plurality of RANs.

14. A method comprising:
detecting a first synchronization signal and physical broadcast channel (SSB) of a first signal beam;
determining, based on the first SSB, a presence of one or more second signal beams, each second signal beam having a footprint at least partially overlapping with a footprint of the first signal beam;
detecting one or more second SSBs of the one or more second signal beams; and
performing an initial-access procedure to a serving cell associated with one or more third SSBs selected from the first and second SSBs.

15. The method of claim 14 further comprising:
determining an initial uplink bandwidth part (BWP) and an initial downlink BWP based on the one or more third SSBs; and
wherein performing the initial-access procedure to the serving cell associated with the one or more third SSBs comprises:
performing the initial-access procedure to the serving cell using the determined initial uplink BWP and initial downlink BWP.

16. The method of claim 14, wherein determining, based on the first SSB, the presence of the one or more second signal beams comprises:
decoding system information based on the first SSB; and
determining the presence of the one or more second signal beams based on the decoded system information.

17. The method of claim 14, wherein the one or more third SSBs are selected based on one or more of reference-signal received powers (RSRPs) of the first SSB and the one or more second SSBs, distances to centers of the first signal beam and the one or more second signal beams, and a probabilistic metric.

18. The method of claim 17, wherein the one or more third SSBs comprise the first SSB when the RSRP of the first SSB is greater than the RSRP of each of the one or more second SSBs by at least a threshold value.

19. The method of claim 17, wherein the one or more third SSBs comprise one of:
the one or more second SSBs whose RSRP is greater than a threshold value, or the first and the one or more second SSBs having the greatest RSRP or the one or more second SSBs, and the one or more third SSBs and the first SSB belong to different types of TRPs or different RANS.

20. The method of claim 14, wherein the one or more third SSBs are selected from a subset of the first SSB and the one or more second SSBs, wherein the subset of the first SSB and the one or more second SSBs are determined based on one or more of a maximum uplink power and an antenna gain.
